(19) United States
(12) Patent Application Publication
(10) Pub. No.: US 2025/0329052 A1
(43) Pub. Date: Oct. 23, 2025

(54) ELECTRONIC DEVICE, PARAMETER CALIBRATION METHOD, AND NON-TRANSITORY COMPUTER READABLE STORAGE MEDIUM

(71) Applicant: HTC Corporation, Taoyuan City (TW)

(72) Inventor: Chen-Yu CHUANG, Taoyuan City (TW)

(21) Appl. No.: 18/639,938

(22) Filed: Apr. 18, 2024

(51) Int. Cl. G06T 7/80

(52) U.S. Cl. CPC G06T 7/80

(57) ABSTRACT

An electronic device is disclosed. The electronic device includes several characteristic patterns, several camera circuits, and a processor. The several camera circuits are configured to capture several images of a reflective surface. The several images comprise several virtual images generated according to the several characteristic patterns. The processor is coupled to the several camera circuits, in which the processor is configured to: update several intrinsic parameters of the several camera circuits and several extrinsic parameters of the several camera circuits according to the several images.

### BACKGROUND

### Field of Invention

The present application relates to an electronic device, a parameter calibration method, and a non-transitory computer readable storage medium. More particularly, the present application relates to an electronic device, a parameter calibration method, and a non-transitory computer readable storage medium for calibrating the parameters of the cameras.

### Description of Related Art

With the advancement of technology, electronic devices are often equipped with cameras to use the images captured by the cameras for measurement, positioning, tracking, identification and other technologies. For technologies such as virtual reality, augmented reality, the accuracy of the parameters of the camera is important. Usually, the parameters of the cameras are calibrated during factory-side automated manufacturing process. However, when a user is operating the electronic device out of the factory, the parameters of the cameras of the electronic device might be drifted caused by long-term use or incorrect use.

Several methods are proposed to calibrate the parameters of the cameras. Traditional camera parameter correction methods include the following. Using the camera to capture a calibration plate of known size and pattern with absolute position, the parameters of the camera are calibrated by utilizing the feature points of the calibration plate with known true positions to re-project back to the camera. However, this calibration method requires a designed calibration plate. Usually the calibration plate is large and has many restrictions, for example, the calibration plate should be flat and should be printed accurately.

Another traditional calibration method use the camera to capture the space where the user is located, capture feature points of unknown scale in the space, and use movement and accumulation of multiple photos to estimate the location and size of these feature points, so as to find the optimized parameters to correct the camera. However, since the information of feature points in the space are estimated, more errors will be caused.

Therefore, how to allow users to accurately calibrate the parameters of the cameras on the device when the performance of the electronic device is poor is a problem to be solved.

### SUMMARY

The disclosure provides an electronic device. The electronic device includes several characteristic patterns, several camera circuits, and a processor. The several camera circuits are configured to capture several images of a reflective surface. The several images comprise several virtual images generated according to the several characteristic patterns. The processor is coupled to the several camera circuits, in which the processor is configured to: update several intrinsic parameters of the several camera circuits and several extrinsic parameters of the several camera circuits according to the several images.

The disclosure provides a parameter calibration method. The parameter calibration method is suitable for an electronic device including several camera circuits. The parameter calibration method includes the following operations: capturing several images of a reflective surface, wherein the several images include several virtual images generated according to several characteristic patterns of the electronic device; and updating several intrinsic parameters of the several camera circuits and several extrinsic parameters of the several camera circuits according to the several images.

The disclosure provides a non-transitory computer readable storage medium with a computer program to execute aforesaid parameter calibration method.

It is to be understood that both the foregoing general description and the following detailed description are by examples and are intended to provide further explanation of the invention as claimed.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is a schematic block diagram illustrating an electronic device in accordance with some embodiments of the present disclosure.

FIG. 2 is a flowchart illustrating a parameter calibration method in accordance with some embodiments of the present disclosure.

FIG. 3 is a schematic diagram illustrating an electronic device in accordance with some embodiments of the present disclosure.

FIG. 4 is a schematic diagram illustrating an operation of the electronic device in accordance with some embodiments of the present disclosure.

FIG. 5 is a flow chart illustrating an operation as illustrated in FIG. 2 in accordance with some embodiments of the present disclosure.

FIG. 6 is a schematic diagram illustrating an image in accordance with some embodiments of the present disclosure.

FIG. 7 is a flow chart illustrating an operation as illustrated in FIG. 2 in accordance with some embodiments of the present disclosure.

FIG. 8 is a schematic diagram illustrating an operation of the electronic device in accordance with some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

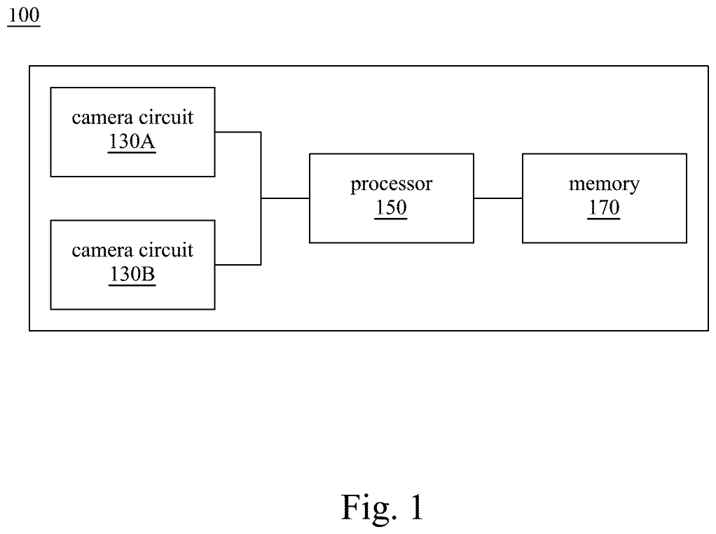

Reference is made to FIG. 1. FIG. 1 is a schematic block diagram illustrating an electronic device 100 in accordance with some embodiments of the present disclosure. As illustrated in FIG. 1, the electronic device 100 includes several camera circuits 130A and 130B, a processor 150, and a memory 170. The several camera circuits 130A and 130B couple to the processor 150, and the memory 170 couples to the processor 150.

It should be noted that, the electronic device 100 in FIG. 1 is for illustrative purposes only, and the embodiments of the present disclosure are not limited thereto.

One or more programs are stored in the memory 170 and are configured to be executed by the processor 150, in order to perform a parameter calibration method.

In some embodiments, the electronic device 100 may be an HMD (head-mounted display) device, a tracking device, or any other device with camera circuits.

In some embodiments, the electronic device 100 may be applied in a virtual reality (VR)/mixed reality (MR)/augmented reality (AR) system. For example, the electronic device 100 may be realized by, a standalone head mounted display device (HMD) or VIVE HMD.

In some embodiments, the processor 150 can be realized by, for example, one or more processing circuits, such as central processing circuits and/or micro processing circuits but are not limited in this regard. In some embodiments, the memory 170 includes one or more memory devices, each of which includes, or a plurality of which collectively include a computer readable storage medium. The non-transitory computer readable storage medium may include a read-only memory (ROM), a flash memory, a floppy disk, a hard disk, an optical disc, a flash disk, a flash drive, a tape, a database accessible from a network, and/or any storage medium with the same functionality that can be contemplated by persons of ordinary skill in the art to which this disclosure pertains.

In some embodiments, the camera circuits 130A and 130B may be a camera with image capturing functions. In some embodiments, the camera circuits 130A and 130B are located inside of the electronic device. The camera circuits 130A and 130B and the characteristic patterns 110A to 110C are formed into the same electronic device 100.

In some embodiments, the electronic device 100 includes other circuits such as a display circuit and an I/O circuit.

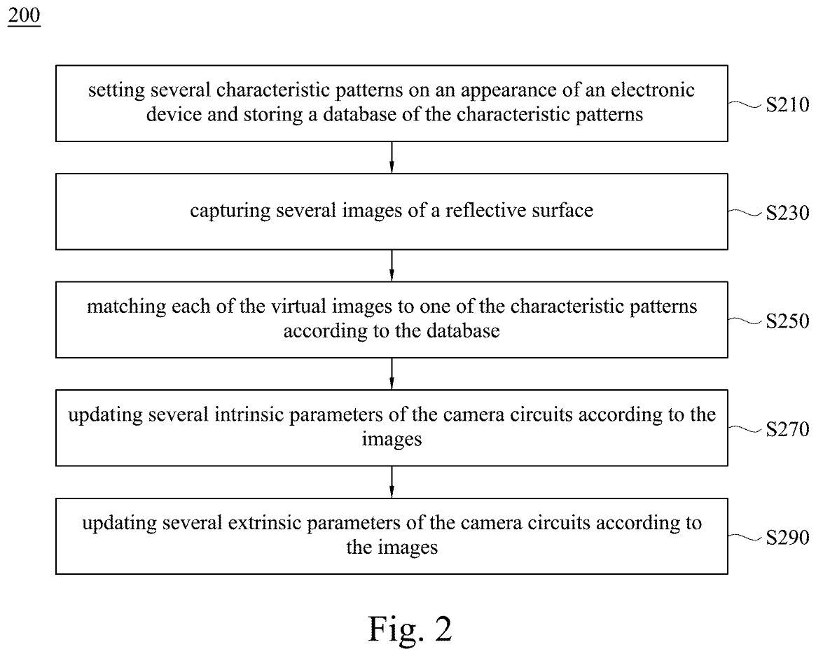

Reference is made to FIG. 2. For better understanding of the present disclosure, the detailed operation of the electronic device 100 as illustrated in FIG. 1 will be discussed in accompanying with the embodiments shown in FIG. 2. FIG. 2 is a flowchart illustrating a parameter calibration method 200 in accordance with some embodiments of the present disclosure. It should be noted that the parameter calibration method 200 can be applied to a device having a structured that is the same as or similar to the structured of the electronic device 100 shown in FIG. 1. To simplify the description below, the embodiments shown in FIG. 1 will be used as an example to describe the parameter calibration method 200 in accordance with some embodiments of the present disclosure. However, the present disclosure is not limited to application to the embodiments shown in FIG. 1.

As shown in FIG. 2, the parameter calibration method 200 includes operations S210 to S290.

In operation S210, several characteristic patterns are set on an appearance of an electronic device and a database of the characteristic patterns is stored.

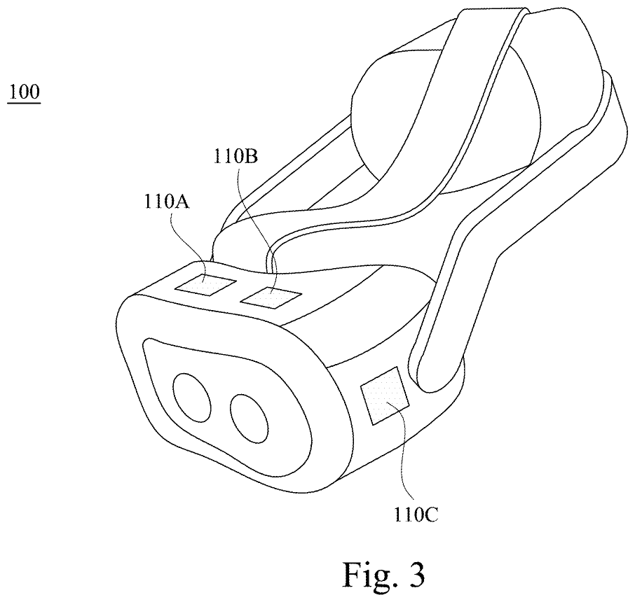

Reference is made to FIG. 3 together. FIG. 3 is a schematic diagram illustrating an electronic device 100 in accordance with some embodiments of the present disclosure. The electronic device 100 as illustrated in FIG. 3 represents an example of a physical appearance of the electronic device 100 as illustrated in FIG. 1. As illustrated in FIG. 3, the electronic device 100 includes characteristic patterns 110A to 110C, the characteristic patterns 110A to 110C are set on the appearance of the electronic device 100. The characteristic patterns 110A to 110C are set at different positions when being made by the factory.

In some embodiments, after the characteristic patterns 110A to 110C are set on the appearance of the electronic device 100, the memory 170 as illustrated in FIG. 1 stores a database including the characteristic patterns 110A to 110C. In some embodiments, the database includes the patterns and the features of the characteristic patterns 110A to 110C, the absolute distances between each of the characteristic patterns 110A to 110C, the positions of the characteristic patterns 110A to 110C relative to the electronic device 100, and so on.

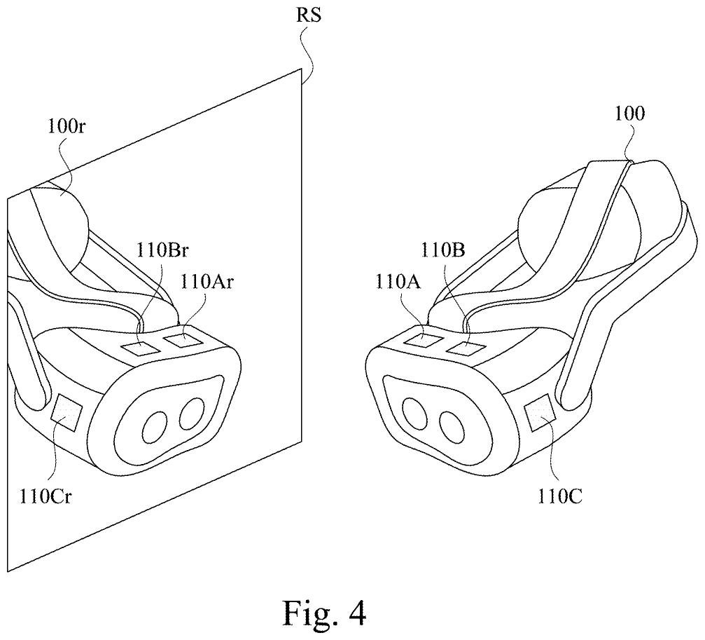

Reference is made to FIG. 2 again. In operation S230, several images of a reflective surface are captured. Reference is made to FIG. 4 together. FIG. 4 is a schematic diagram illustrating an operation of the electronic device 100 in accordance with some embodiments of the present disclosure. As illustrated in FIG. 4, the reflective surface RS is a flat mirror. The reflective surface RS shows the virtual images generated according to the electronic device 100 and the characteristic patterns 110A to 110C. As illustrated in FIG. 4, the reflective surface RS shown the virtual image 100r of the electronic device 100, the virtual image 110Ar of the characteristic pattern 110A, the virtual image 110Br of the characteristic pattern 110B, and the virtual image 110Cr of the characteristic pattern 110C.

Since the camera circuits 130A and 130B and the characteristic patterns 110A to 110C are formed into the same electronic device 100, when the camera circuits 130A and 130B capture the images of the reflective surface RS, the images of the reflective surface RS include the virtual images 110Ar, 110Br, and 110Cr of the characteristic patterns 110A to 110C.

In some embodiments, the camera circuits 130A and 130B captures the images of the reflective surface RS with the electronic device 100 located in front of the reflective surface RS with specific distance and/or specific angle.

Reference is made to FIG. 2 again. In operation S250, each of the virtual images is matched to one of the characteristic patterns according to the database. In some embodiments, in operation S250, the processor 150 matches the virtual images 110Ar to 110Cr as illustrated in FIG. 4 to the characteristic patterns 110A to 110C according to the database stored in the memory 170.

For example, in one embodiment, according to the pattern of the virtual image 110Ar, the processor 150 searches the database and finds that the pattern of the virtual image 110Ar is closest to the characteristic pattern 110A; the processor 150 matches the virtual image 110Ar to the characteristic pattern 110A. The processor obtains that the virtual image 110Ar is a virtual image of the characteristic pattern 110A by matching the pattern of the virtual image 110Ar and the pattern of the characteristic pattern 110A. In some other embodiments, the processor 150 matches the virtual images 110Ar to 110Cr as illustrated in FIG. 4 to the characteristic patterns 110A to 110C according to the positions of the characteristic patterns 110A to 110C relative to the electronic device 100 and the positions of the virtual images 110Ar to 110Cr relative to the virtual image 100r of the electronic device 100.

Reference is made to FIG. 2 again. In operation S270, several intrinsic parameters of the camera circuits are updated according to the images. In some embodiments, operation S270 is operated by the processor 150 as illustrated in FIG. 1.

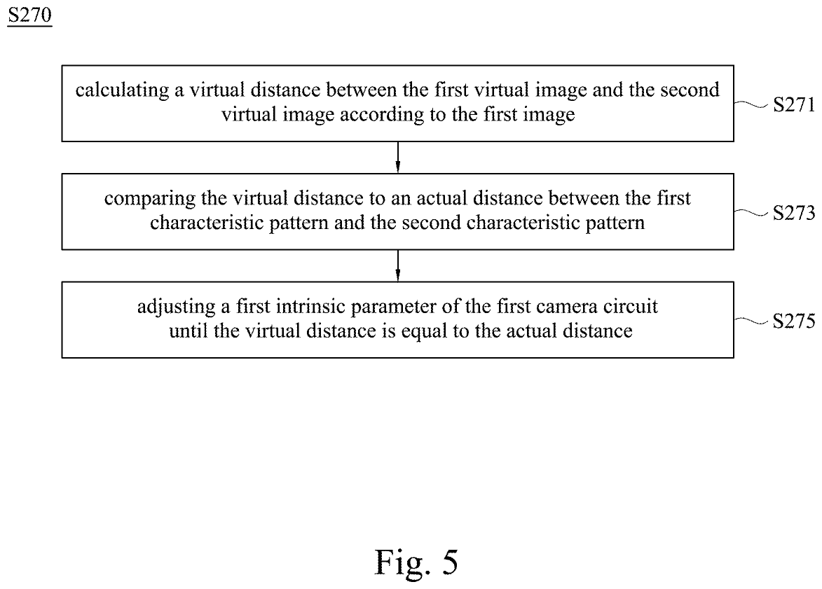

Reference is made to FIG. 5 together. FIG. 5 is a flow chart illustrating operation S270 as illustrated in FIG. 2 in accordance with some embodiments of the present disclosure. As illustrated in FIG. 5, operation S270 includes operations S271 to S275.

In operation S271, a virtual distance between the first virtual image and the second virtual image is calculated according to the first image.

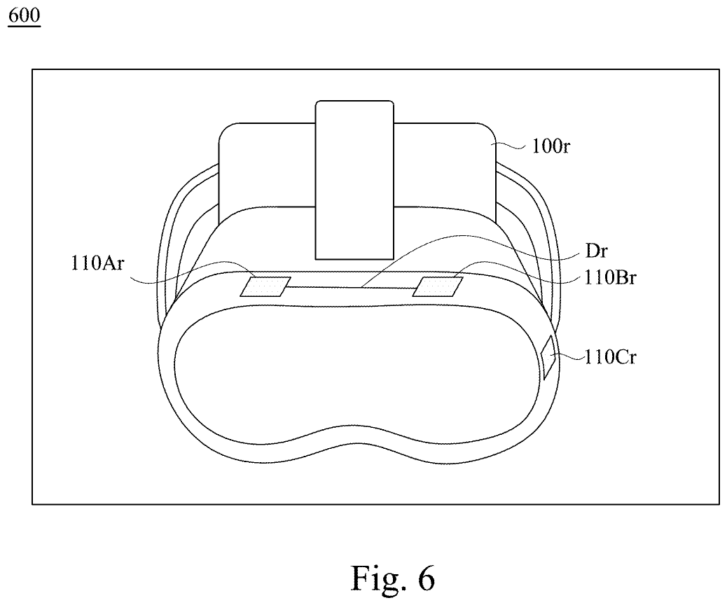

Reference is made to FIG. 6 together. FIG. 6 is a schematic diagram illustrating an image 600 in accordance with some embodiments of the present disclosure. In some embodiment, the camera circuit 130A as illustrated in FIG. 1 captures the reflective surface RS as illustrated in FIG. 4 with the electronic device located in front of the reflective surface RS, and the camera circuit 130A obtains the image 600 as illustrated in FIG. 6.

As illustrated in FIG. 6, the image 600 includes the virtual image 100r of the electronic device 100, the virtual image 110Ar of the characteristic pattern 110A, the virtual image 110Br of the characteristic pattern 110B, and the virtual image 110Cr of the characteristic pattern 110C.

In some embodiments, according to the image 600, the processor 150 as illustrated in FIG. 1 calculates the virtual distance Dr between the virtual image 110Ar and the virtual image 110Br.

Reference is made to FIG. 5 again. In operation S273, the virtual distance is compared to an actual distance between the first characteristic pattern and the second characteristic pattern.

In some embodiments, the memory 170 as illustrated in FIG. 1 stores the absolute distance between the characteristic pattern 110A and the characteristic pattern 110B, in which the absolute distance between the characteristic pattern 110A and the characteristic pattern 110B is taken as the actual distance between the characteristic pattern 110A and the characteristic pattern 110B.

In operation S275, a first intrinsic parameter of the first camera circuit is adjusted until the virtual distance is equal to the actual distance.

In some embodiments, the processor 150 as illustrated in FIG. 1 adjusts the intrinsic parameter of the camera circuit 130A until the virtual distance Dr as illustrated in FIG. 6 is equal to the actual distance between the characteristic pattern 110A and the characteristic pattern 110B.

In some embodiments, the intrinsic parameter includes the optical center and the focal length of each of the camera circuits 130A and 130B. In some embodiments, the intrinsic parameters represent a projective transformation from the 3D camera's coordinates into the 2D image coordinates. In some embodiments, the processor 150 adjusts the optical length and/or the focal length of the camera circuits 130A until the virtual distance Dr as illustrated in FIG. 6 is equal to the actual distance between the characteristic pattern 110A and the characteristic pattern 110B.

Reference is made to FIG. 2 again. In operation S290, several extrinsic parameters of the camera circuits are updated according to the images. In some embodiments, operation S290 is operated by the processor 150 as illustrated in FIG. 1.

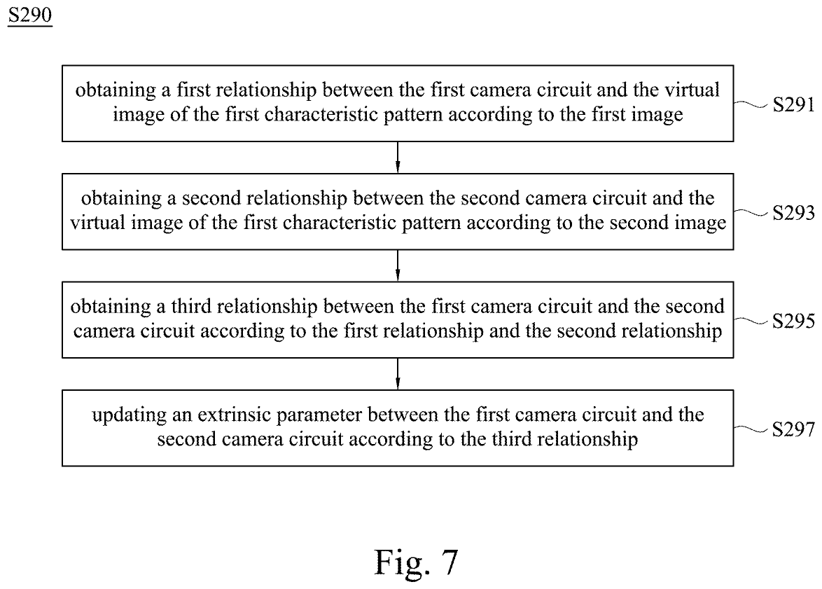

Reference is made to FIG. 7 together. FIG. 7 is a flow chart illustrating operation S290 as illustrated in FIG. 2 in accordance with some embodiments of the present disclosure. As illustrated in FIG. 7, operation S290 includes operations S291 to S297.

In operation S291, a first relationship between the first camera circuit and the virtual image of the first characteristic pattern is obtained according to the first image.

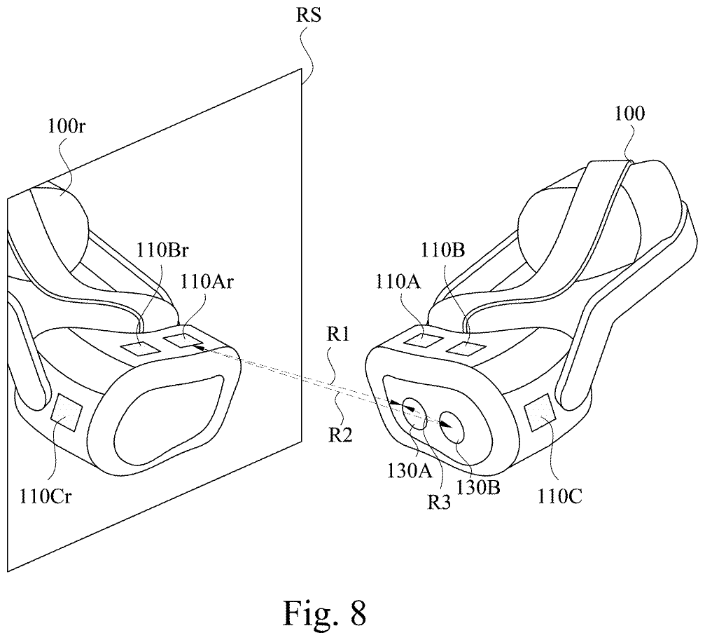

Reference is made to FIG. 8 together. FIG. 8 is a schematic diagram illustrating an operation of the electronic device 100 in accordance with some embodiments of the present disclosure. As illustrated in FIG. 8, the camera circuit 130A captures an image of the reflective surface RS with the electronic device 100 located in front of the reflective surface RS and the reflective surface RS showing the virtual image 100r of the electronic device 100. According to the image of the reflective surface RS captured by the camera circuit 130A, the processor 150 obtains a relationship between the camera circuit 130A and the virtual image 110Ar of the characteristic pattern 110A.

Reference is made to FIG. 7 again. In operation S293, a second relationship between the second camera circuit and the virtual image of the first characteristic pattern is obtained according to the second image.

Reference is made to FIG. 8 together. As illustrated in FIG. 8, the camera circuit 130B captures an image of the reflective surface RS with the electronic device 100 located in front of the reflective surface RS and the reflective surface RS showing the virtual image 100r of the electronic device 100. According to the image of the reflective surface RS captured by the camera circuit 130B, the processor 150 obtains a relationship between the camera circuit 130B and the virtual image 110Ar of the characteristic pattern 110A.

In some embodiments, the memory 170 stores a SLAM (Simultaneous localization and mapping) module. The electronic device 100 may be configured to process the SLAM module. The SLAM module includes functions such as image capturing, features extracting from the image, and localizing according to the extracted features. In some embodiments, the SLAM module include a SLAM algorithm, in which the processor 150 access and process the SLAM module so as to obtain the relationship between the camera circuit 130A and the virtual image 110Ar of the characteristic pattern 110A and the relationship between the camera circuit 130B and the virtual image 110Ar of the characteristic pattern 110A.

In operation S295, a third relationship between the first camera circuit and the second camera circuit is obtained according to the first relationship and the second relationship. For example, as illustrated in FIG. 8, in some embodiments, the processor 150 as illustrated in FIG. 1 obtains the relationship R3 between the camera circuits 130A and 130B according to the relationship R1 between the camera circuit 130A and the virtual image 110Ar and the relationship R2 between the camera circuit 130B and the virtual image 110Ar. In some embodiments, the difference between the relationship R1 and the relationship R2 is taken as the relationship R3 between the camera circuits 130A and 130B. In some embodiments, the relationship R3 includes a relative distance and a relative rotation between the camera circuits 130A and 130B.

In operation S297, an extrinsic parameter between the first camera circuit and the second camera circuit is updated according to the third relationship. In some embodiments, the processor 150 as illustrated in FIG. 1 updates the extrinsic parameter between the camera circuits 130A and 130B stored in the memory 170 as illustrated in FIG. 1 according to the relationship R3. In some embodiments, the relationship R3 is taken as the extrinsic parameter between the camera circuits 130A and 130B. In some embodiments, the extrinsic parameter includes a relative distance and a relative rotation between the camera circuits 130A and 130B.

Through the operations of various embodiments described above, an electronic device, a parameter calibration method, and a non-transitory computer readable storage medium are implemented. In the embodiments of the present disclosure, the characteristic patterns are designed on the appearance of the electronic device, and the characteristic patterns are hence easy to be adjusted. With the characteristic patterns, the users can utilize the reflective surface to calibrate the cameras on the electronic device. The calibration process is possible for the general users because there is no need for hard-to-obtain and bulky calibration plates, in which the portability of the electronic device is increased. Moreover, since reflective surfaces are common in the household, there is no need to purchase additional devices, and there is no need to introduce new components at the production end or the factory end. Furthermore, instead of estimating feature points first and then calibrating the cameras, the present disclosures utilize the known feature points directly for calibration, resulting in less error and high accuracy.

It should be noted that in the operations of the abovementioned parameter calibration method 200, no particular sequence is required unless otherwise specified. Moreover, the operations may also be performed simultaneously or the execution times thereof may at least partially overlap.

Furthermore, the operations of the parameter calibration method 200 may be added to, replaced, and/or eliminated as appropriate, in accordance with various embodiments of the present disclosure.

Various functional components or blocks have been described herein. As will be appreciated by persons skilled in the art, the functional blocks will preferably be implemented through circuits (either dedicated circuits, or general purpose circuits, which operate under the control of one or more processing circuits and coded instructions), which will typically include transistors or other circuit elements that are configured in such a way as to control the operation of the circuitry in accordance with the functions and operations described herein.

Although the present disclosure has been described in considerable detail with reference to certain embodiments thereof, other embodiments are possible. Therefore, the scope of the appended claims should not be limited to the description of the embodiments contained herein.

It will be apparent to those skilled in the art that various modifications and variations can be made to the structured of the present invention without departing from the scope or spirit of the invention. In view of the foregoing, it is intended that the present invention cover modifications and variations of this invention provided they fall within the scope of the following claims.

What is claimed is:

1. An electronic device, comprising:
a plurality of characteristic patterns;
a plurality of camera circuits, configured to capture a plurality of images of a reflective surface, wherein the plurality of images comprise a plurality of virtual images generated according to the plurality of characteristic patterns; and
a processor, coupled to the plurality of camera circuits, wherein the processor is configured to:
update a plurality of intrinsic parameters of the plurality of camera circuits and a plurality of extrinsic parameters of the plurality of camera circuits according to the plurality of images.

2. The electronic device of claim 1, wherein the plurality of characteristic patterns are set on an appearance of the electronic device.

3. The electronic device of claim 1, wherein the plurality of characteristic patterns comprise a first characteristic pattern and a second characteristic pattern, wherein a first camera circuit of the plurality of camera circuits is configured to capture a first image of the plurality of images, and the first image comprise a first virtual image of the first characteristic pattern and a second virtual image of the second characteristic pattern, and the processor is further configured to:
calculate a virtual distance between the first virtual image and the second virtual image according to the first image;
compare the virtual distance to an actual distance between the first characteristic pattern and the second characteristic pattern; and
adjust a first intrinsic parameter of the plurality of intrinsic parameters of the first camera circuit until the virtual distance is equal to the actual distance.

4. The electronic device of claim 1, wherein the plurality of characteristic patterns comprise a first characteristic pattern, wherein a first camera circuit of the plurality of camera circuits is configured to capture a first image of the plurality of images, and a second camera circuit of the plurality of camera circuits is configured to capture a second image of the plurality of images, wherein both of the first image and the second image comprise a first virtual image of the first characteristic pattern, and the processor is further configured to:
obtain a first relationship between the first camera circuit and the first virtual image according to the first image;
obtain a second relationship between the second camera circuit and the first virtual image according to the second image;
obtain a third relationship between the first camera circuit and the second camera circuit according to the first relationship and the second relationship; and
update an extrinsic parameter between the first camera circuit and the second camera circuit according to the third relationship.

5. The electronic device of claim 4, wherein the third relationship comprises a relative distance and a relative rotation between the first camera circuit and the second camera circuit.

6. The electronic device of claim 1, further comprising:
a memory, coupled to the plurality of camera circuits and the processor, wherein the memory is configured to:
store a database comprising the plurality of characteristic patterns, the plurality of intrinsic parameters and the plurality of extrinsic parameters.

7. The electronic device of claim 6, wherein the processor is further configured to:
match each of the plurality of virtual images to one of the plurality of characteristic patterns according to the database.

8. A parameter calibration method, suitable for an electronic device comprising a plurality of camera circuits, comprising:
capturing a plurality of images of a reflective surface, wherein the plurality of images comprise a plurality of virtual images generated according to a plurality of characteristic patterns of the electronic device; and
updating a plurality of intrinsic parameters of the plurality of camera circuits and a plurality of extrinsic parameters of the plurality of camera circuits according to the plurality of images.

9. The parameter calibration method of claim 8, wherein the plurality of characteristic patterns are set on an appearance of the electronic device.

10. The parameter calibration method of claim 8, further comprising:
capturing a first image of the plurality of images by a first camera circuit of the plurality of camera circuits, wherein the plurality of characteristic patterns comprise a first characteristic pattern and a second characteristic pattern, and the first image comprise a first virtual image of the first characteristic pattern and a second virtual image of the second characteristic pattern;
calculating a virtual distance between the first virtual image and the second virtual image according to the first image;
comparing the virtual distance to an actual distance between the first characteristic pattern and the second characteristic pattern; and
adjusting a first intrinsic parameter of the plurality of intrinsic parameters of the first camera circuit until the virtual distance is equal to the actual distance.

11. The parameter calibration method of claim 8, further comprising:
capturing a first image of the plurality of images by a first camera circuit of the plurality of camera circuits;
capturing a second image of the plurality of images by a second camera circuit of the plurality of camera circuits, wherein the plurality of characteristic patterns comprise a first characteristic pattern, and both of the first image and the second image comprise a first virtual image of the first characteristic pattern;
obtaining a first relationship between the first camera circuit and the first virtual image according to the first image;
obtaining a second relationship between the second camera circuit and the first virtual image according to the second image;
obtaining a third relationship between the first camera circuit and the second camera circuit according to the first relationship and the second relationship; and
updating an extrinsic parameter between the first camera circuit and the second camera circuit according to the third relationship.

12. The parameter calibration method of claim 11, wherein the third relationship comprises a relative distance and a relative rotation between the first camera circuit and the second camera circuit.

13. The parameter calibration method of claim 8, further comprising:
storing a database comprising the plurality of characteristic patterns, the plurality of intrinsic parameters and the plurality of extrinsic parameters by a memory of the electronic device.

14. The parameter calibration method of claim 13, further comprising:
matching each of the plurality of virtual images to one of the plurality of characteristic patterns according to the database.

15. A non-transitory computer readable storage medium, wherein the non-transitory computer readable storage medium comprises one or more computer programs stored therein, and the one or more computer programs can be executed by one or more processors so as to be configured to operate a parameter calibration method, wherein the parameter calibration method comprises:
capturing a plurality of images of a reflective surface, wherein the plurality of images comprise a plurality of virtual images generated according to a plurality of characteristic patterns of an electronic device; and
updating a plurality of intrinsic parameters of a plurality of camera circuits of the electronic device and a plurality of extrinsic parameters of the plurality of camera circuits of the electronic device according to the plurality of images.

16. The non-transitory computer readable storage medium of claim 15, wherein the plurality of characteristic patterns are set on an appearance of the electronic device.

17. The non-transitory computer readable storage medium of claim 15, wherein the parameter calibration method further comprises:
capturing a first image of the plurality of images by a first camera circuit of the plurality of camera circuits, wherein the plurality of characteristic patterns comprise a first characteristic pattern and a second characteristic pattern, and the first image comprise a first virtual image of the first characteristic pattern and a second virtual image of the second characteristic pattern;
calculating a virtual distance between the first virtual image and the second virtual image according to the first image;
comparing the virtual distance to an actual distance between the first characteristic pattern and the second characteristic pattern; and
adjusting a first intrinsic parameter of the plurality of intrinsic parameters of the first camera circuit until the virtual distance is equal to the actual distance.

18. The non-transitory computer readable storage medium of claim 15, wherein the parameter calibration method further comprises:
capturing a first image of the plurality of images by a first camera circuit of the plurality of camera circuits;
capturing a second image of the plurality of images by a second camera circuit of the plurality of camera circuits, wherein the plurality of characteristic patterns comprise a first characteristic pattern, and both of the first image and the second image comprise a first virtual image of the first characteristic pattern;
obtaining a first relationship between the first camera circuit and the first virtual image according to the first image;
obtaining a second relationship between the second camera circuit and the first virtual image according to the second image;
obtaining a third relationship between the first camera circuit and the second camera circuit according to the first relationship and the second relationship; and
updating an extrinsic parameter between the first camera circuit and the second camera circuit according to the third relationship.

19. The non-transitory computer readable storage medium of claim 18, wherein the third relationship comprises a relative distance and a relative rotation between the first camera circuit and the second camera circuit.

20. The non-transitory computer readable storage medium of claim 15, wherein the parameter calibration method further comprises:
storing a database comprising the plurality of characteristic patterns, the plurality of intrinsic parameters and the plurality of extrinsic parameters by a memory of the electronic device; and
matching each of the plurality of virtual images to one of the plurality of characteristic patterns according to the database.
